(19) United States
(12) Patent Application Publication
(10) Pub. No.: US 2025/0244765 A1
(43) Pub. Date: Jul. 31, 2025

(54) NAVIGATING AN UNMANNED GROUND VEHICLE

(71) Applicant: ELECTRIC SHEEP ROBOTICS, INC., Pleasanton, CA (US)

(72) Inventors: Naganand MURTY, San Anselmo, CA (US); Gunjit SINGH, San Francisco, CA (US); Jarrett Jeffrey HEROLD, Pleasanton, CA (US)

(73) Assignee: ELECTRIC SHEEP ROBOTICS, INC., Pleasanton, CA (US)

(21) Appl. No.: 18/853,313

(22) PCT Filed: Apr. 22, 2022
(86) PCT No.: PCT/US2022/025988

§ 371 Date: Oct. 1, 2024

(51) Int. Cl. G05D 1/249; G05D 1/246; G05D 1/622; G05D 1/648; G05D 105/00; G05D 105/10; G05D 105/15; G05D 107/20; G05D 107/70

(52) U.S. Cl. CPC G05D 1/249; G05D 1/2462; G05D 1/622; G05D 1/648; G05D 2105/10; G05D 2105/12; G05D 2105/15; G05D 2105/17; G05D 2107/21; G05D 2107/23; G05D 2107/70

(57) ABSTRACT

A method for navigating an unmanned ground vehicle (UGV) includes obtaining, by a sensor spaced apart from the UGV and at least temporarily fixed relative to a stretch of land on which the UGV is to operate, a three-dimensional map of the stretch of land. A navigation signal is generated based on the three-dimensional map and a user-specified task. The navigation signal is transmitted to a controller operatively coupled to the UGV, and configured to receive a navigation signal and operate the UGV in accordance with the navigation signal.

### TECHNICAL FIELD

The systems, devices and methods disclosed herein are directed to unmanned ground vehicles, and in particular to navigation of unmanned ground vehicles.

### BACKGROUND

Autonomous or unmanned vehicles are commonly used in transportation of goods and persons on mapped roads and well-defined tracks. However, reliable navigation of unmanned vehicles over unmapped and/or uneven terrain has been challenging because of issues posed by identification of obstacles and navigating the vehicle around those obstacles.

One of the challenges in identification of obstacles and navigating those vehicles around those obstacles is that the sensors enabling the autonomous or unmanned vehicle to identify the obstacles are on the vehicle (i.e., “ego-mode” sensors), thereby limiting the perspective of the sensors. Such “ego-mode” sensors also limit the vehicle's ability to detect (and consequently identify) objects beyond the vehicle's visual range and thereby perceive itself within the terrain. As a result, on unmapped and uneven terrains, it is difficult for a vehicle with “ego-mode” sensors to localize itself relative to the terrain. Consequently, the vehicle with “ego-mode” sensors is unable to plan an optimal path for traversing the terrain from one point to another.

### SUMMARY

The devices, systems and methods of the present disclosure are derived from the realization that “ego-mode” sensors have inherent limitations for navigating an unmanned vehicle that can be overcome by providing a motion capture sensor, outside of the vehicle, that is at a fixed vantage point that is not on the vehicle and is momentarily stationary relative to the vehicle. Capturing motion of the vehicle using a sensor at a fixed vantage point away from the vehicle enables the vehicle to: localize itself relative to the terrain on which it is operating, perceive the terrain beyond the vehicle's visual range, and plan an optimal path for traversing the terrain while avoiding collisions. Thus, the devices, systems and methods of the present disclosure provide a new paradigm in navigating unmanned vehicles on an unmapped and uneven terrain.

Consequently, unmanned vehicles using the devices, methods and systems of the present disclosure enable navigation of unmanned vehicles in environments with unmapped and difficult terrains such as, for example, backyards, golf courses, farm land, construction sites, solar farms, wind farms, mining sites, and the like. The ability to provide a perspective beyond the vehicle's visual range also enables vehicles using the devices, methods and systems of the present disclosure to navigate in indoor spaces such as warehouses and in environments where potential obstacles may be obscured by external factors such as snow-covered roads and yards.

The devices, methods and systems of the present disclosure are derived from a further realization that a fixed vantage point for a motion capture sensor can be provided using a camera or a sensor that is mounted on a fixed platform which is affixed to the land on which the vehicle is to be operated such as, for example, a roof, a pole or a tree, as well as a platform that can be momentarily fixed such as, for example, a drone, a balloon or an on-ground platform that can be moved independently of the vehicle being operated.

Thus, in an aspect of the present disclosure, a system for navigating an unmanned ground vehicle (UGV) includes the UGV comprising a controller configured to receive a navigation signal and operate the UGV in accordance with the navigation signal. The UGV has an identifying marker provided thereon. A sensor is provided to be spaced apart from the UGV and at least temporarily fixed relative to a stretch of land on which the UGV is to operate. The sensor is configured to obtain a three-dimensional (3D) map of the stretch of land. The system may further include one or more processors configured to generate the navigation signal based on the 3D map and a user-specified task, and transmit the navigation signal to the controller. The one or more processors may be provided on the UGV, at the sensor or away from both the UGV and the sensor.

In another aspect of the present disclosure, a method for operating an unmanned ground vehicle (UGV) includes obtaining, by a sensor spaced apart from the UGV and at least temporarily fixed relative to a stretch of land on which the UGV is to operate, a three-dimensional (3D) map of the stretch of land. A navigation signal is generated based on the 3D map and a user-specified task. The vehicle is then operated using the navigation signal.

In another aspect of the present disclosure, an unmanned ground vehicle (UGV) includes an identifying marker disposed on a top side and/or along one or more sides of the UGV. The identifying marker is configured to enable an external sensor to distinguish the vehicle from a surrounding stretch of land. The vehicle further includes a controller configured to receive a navigation signal and operate the vehicle autonomously in accordance with the navigation signal. The navigation signal is generated based on a three-dimensional (3D) map of the stretch of land on which the vehicle is to operate. The navigation signal includes information relating to a pose and a velocity of the UGV relative to the stretch of land determined using the identifying marker by the external sensor. The navigation signal is based on the 3D map and a user-specified task.

In another aspect of the present disclosure, a non-transitory computer-readable medium includes instructions stored thereon which cause one or more processors to perform operations including receiving a three-dimensional (3D) map of a stretch of land on which an unmanned ground vehicle (UGV) is to operate. The 3D map is received from a sensor spaced apart from the UGV and at least temporarily fixed relative to the stretch of land. The 3D map includes information relating to a pose and a velocity of the UGV relative to the stretch of land. The operations further include generating a navigation signal based on the 3D map and a user-specified task. The navigation signal includes a prospective path for movement of the UGV. The operations further include operating the UGV in accordance with the navigation signal.

In another aspect of the present disclosure, a non-transitory computer-readable medium includes instructions stored thereon which cause one or more processors to perform operations including obtaining a three-dimensional (3D) map of a stretch of land by a sensor spaced apart from an unmanned ground vehicle (UGV) at least temporarily fixed relative to the stretch of land which the UGV is to operate. The operations further include generating a navigation signal based on the 3D map and a user specified task and transmitting the navigation signal to the UGV to enable the UGV to operate in accordance with the navigation signal.

In another aspect of the present disclosure, a method for navigating an unmanned ground vehicle (UGV) includes receiving a three-dimensional (3D) map of a stretch of land on which the UGV is to operate. The 3D map includes information relating to a pose and a velocity of the UGV relative to the stretch of land. A navigation signal is generated based on the 3D map and a user-specified task. The navigation signal includes a prospective path for movement of the UGV on the stretch of land. The UGV is then operated in accordance with the navigation signal.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A shows a schematic of the system for navigating a UGV, in accordance with some embodiments of the present disclosure.

FIG. 1B illustrates a block diagram of a system for navigating an unmanned ground vehicle in accordance with some embodiments of the present disclosure.

FIG. 2 illustrates the use of a second vehicle as a platform for providing sensors to enable navigation of an unmanned ground vehicle, in accordance with some embodiments of the present disclosure.

FIG. 3 is a flow chart illustrating an example method for generating a navigation signal in accordance with at least some embodiments of the present disclosure.

FIG. 4 illustrates a flow chart for a method for obstacle avoidance for a ground maintenance robot in accordance with at least some embodiments of the present disclosure.

### DETAILED DESCRIPTION

Many tasks require movement of a vehicle over an unmapped stretch of land with an uneven terrain. In some instances, the vehicle may be moved over certain features of the terrain; however, other features may require the vehicle to navigate around them while maintaining a path enabling the vehicle to perform the assigned task.

Conventionally, an autonomous or unmanned ground vehicle (UGV) uses a sensor stack provided on-board the UGV to enable the UGV to navigate along a path. Such on-board sensor stack is often referred to as “ego-mode” sensors because the visual perspective provided by the on-board sensors is from the point of view of the UGV. Ego-mode sensing of a terrain has inherent limitations because the vehicle cannot perceive the terrain beyond the visual range of the sensors. Thus, a sensor stack that can provide a perspective different from an ego-mode perspective may be useful when navigating a UGV over an uneven terrain, particularly, in situations where the terrain may have obstacles that need to be navigated around.

The devices, methods, and systems disclosed herein are based on a paradigm shift in sensing of a terrain for navigating a UGV by using sensor stack that is spaced apart from the UGV. Such a sensor stack can distinguish the UGV from the terrain, generate a map of the terrain and plan a path to allow the UGV to perform a given task while avoiding a set of features (referred to herein as obstacles) on the terrain.

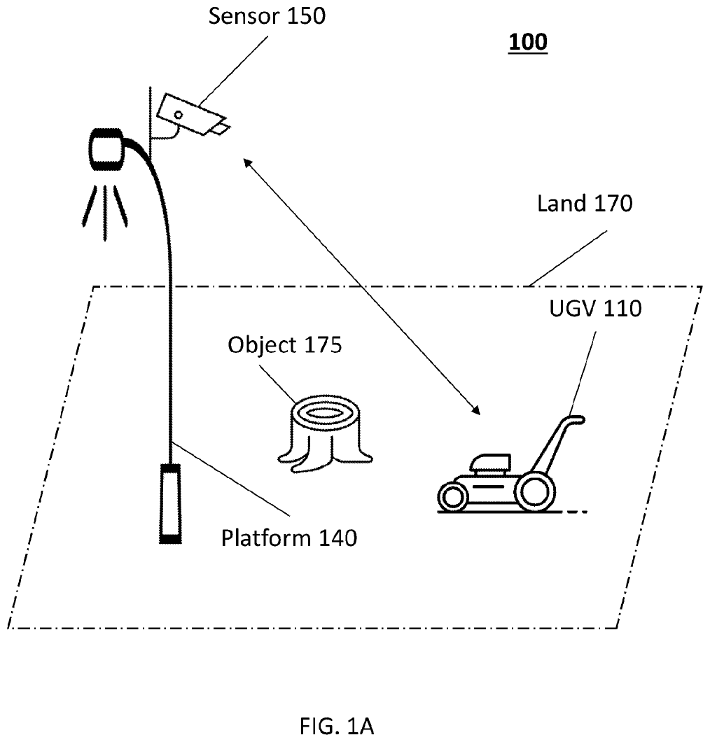

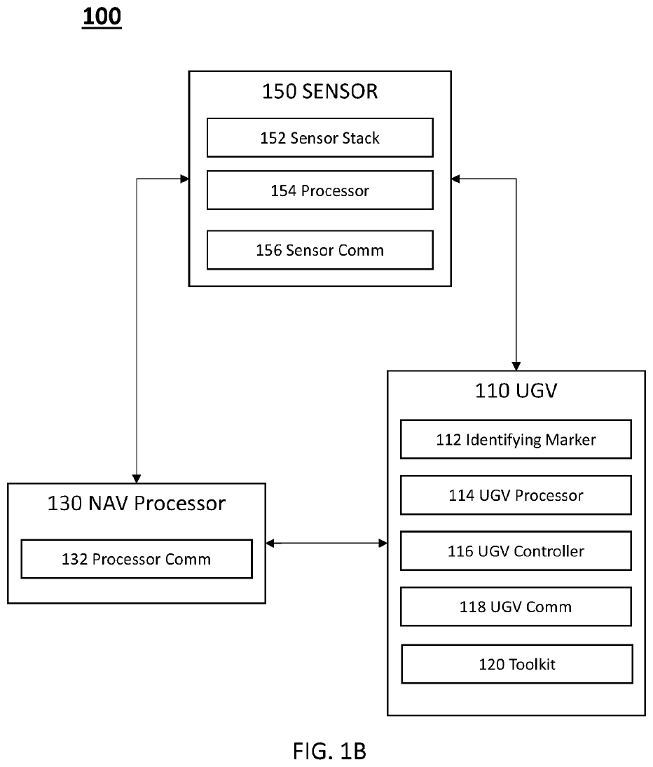

FIG. 1A shows a schematic of the system for navigating a UGV, in accordance with some embodiments of the present disclosure. In an implementation, the system 100 includes an unmanned ground vehicle (UGV) 110 and a sensor 150 mounted to a platform 140 that is spaced apart from the UGV 110.

The platform 140 may be at least temporarily fixed relative to the stretch of land on which the UGV 110 is to operate. In some implementations, the platform 140 may be a pole, a wall, a roof, or a tree located on the stretch of land. In some embodiments, the platform 140 is a second vehicle that periodically follows the UGV 110. The second vehicle may, for example, be a ground vehicle or an aerial vehicle. Non-limiting examples of an aerial vehicle that can function as the platform 140 include a drone, a balloon, a blimp, an airship, a Zeppelin, a VTOL aircraft and a helicopter.

### A. Unmanned Ground Vehicle

The term “unmanned ground vehicle” or UGV as used herein refers to a vehicle capable of being operated or supervised locally or remotely by a human user as well as being capable of functioning autonomously. It will be understood that functioning autonomously does not necessarily mean functioning fully autonomously without any human supervision or support. In other words, functioning autonomously as used herein does not refer to Level 5 automation. Thus, a UGV in accordance with an implementation of the present disclosure can function autonomously; however, a human user can override the autonomous control of the UGV and control it locally or remotely.

In some embodiments, the UGV is a robotic grounds maintenance vehicle that can perform one or more functions including, but not limited to, lawn mowing, bush trimming, snow removal, seeding, aerating, watering, and dispensing of a fertilizer, a pesticide or a herbicide. In some embodiments, the UGV is a road-maintenance robot that can perform one or more functions including, but not limited to, snow removal, preventive management, salt or brine spraying, painting, and damage maintenance.

In some embodiments, the UGV is a robotic agricultural vehicle that can perform one or more functions including, but not limited to, tilling, seeding, spraying of a fertilizer, a pesticide or a herbicide, and harvesting.

In some embodiments, the UGV is a solar farm maintenance robot that can perform one or more functions including, but not limited to, installation, repair and cleaning of solar panels.

In some embodiments, the UGV is a warehouse robot that can perform one or more functions including, but not limited to, loading and/or unloading of shelves, collecting objects from shelves, packaging objects, and transporting objects from one point to another within a warehouse space.

In some embodiments, the UGV is a mining robot that can perform one or more functions including, but not limited to, mine development, drilling, blasting, extraction, milling, crushing, screening, or sizing of minerals at a mine; maintenance and repair of mining equipment; and associated haulage of materials within the mine from these activities.

In some embodiments, the UGV is a robotic construction vehicle that can perform functions including, but not limited to, land digging, plastering, concrete work, installation work, foundations and roof erection, joinery work, exterior and interior finish, setting in motion and adjustment of equipment.

In some embodiments, the UGV may be a vegetation abatement robot that can perform the tasks relating to prevention of wildfires such as, for example, clearing of flammable materials along a dry landscape. In some embodiments, the UGV may be used for performing fire control by spraying water around the edges of a wildfire.

Any other types of vehicles that require navigation over mapped or unmapped uneven terrain are contemplated within the scope of the present disclosure.

FIG. 1B illustrates a block diagram of a system for navigating an unmanned ground vehicle in accordance with some embodiments of the present disclosure. Referring to FIG. 1B, the UGV 110 includes a motor (powered by a battery, fossil fuel, alternative fuel and/or any other power source), a power supply, and means to enable the UGV 110 to move on the stretch of land 170 and navigate the terrain including obstacles 200. In addition, the UGV 110 includes an identifying marker 112, a UGV processor 114, a UGV controller 116, a UGV communication module 118, and a toolkit 120.

The identifying marker 112 may be a machine readable marker enabling sensor 150 to distinguish the UGV 110 from the surrounding stretch of land 170. In some embodiments, the identifying marker 112 or at least a portion of the identifying marker 112 may be disposed on a top side and/or along one or more sides of the UGV 110. In some embodiments, the identifying marker 112 includes a two-dimensional and/or a three-dimensional structure such as, for example, an ArUco marker. In some embodiments, the identifying marker 112 may be detectable across the electromagnetic spectrum. For example, the identifying marker 112 may be detectable in one or more of optical frequencies, infrared frequencies and ultraviolet frequencies. In some embodiments, the identifying marker 112 may include a multi-colored two-dimensional code such, as for example, a multi-colored QR code. In some embodiments, the identifying marker 112 may include a textured code. In some embodiments, the identifying marker 112 may be unique to the vehicle.

The identifying marker 112 may be designed to enable the sensor 150 to detect a pose and/or orientation of the UGV 110 relative to the stretch of land 170.

The processor 114 may include one or more processors such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

In some embodiments, the processor 114 processes data received the sensor 150 or the NAV processor 130 to generate a navigation signal for navigating the UGV 110 on a stretch of land. In some embodiments, the processor 114 processes the commands and controls and transmits them to the UGV controller 116 which then controls the engine and toolkit 120 of the UGV 110 to navigate and operate the UGV 110 in accordance with navigation signal.

In some embodiments, the UGV controller 116 may generate signals for controlling the operation of the one or more actuators. For example, in some embodiments, the UGV controller 116 may change the operating speed at which the actuators perform the task based on latency of communication (e.g., navigation or operational commands) being received from the NAV processor 130 and/or the sensor 150.

The signals generated by the UGV controller 116 enable autonomous operation of the UGV 110 in some embodiments. In some embodiments, the autonomous operation of the UGV 110 is possible within a predetermined range of the sensor 150.

In some embodiments, the UGV 110 may be a tele-operated robot that can be controlled from a remote location. In some embodiments, the UGV 110 may be tele-operated outside a predetermined range. In such embodiments, the UGV controller 116 may calculate the minimum reaction time needed to tele-supervise/tele-operate in a given obstacle density (and a given view), and calculate a minimum stopping distance (both for motion/any kind of dexterous manipulation) under the constraints of this reaction time. Control of any other operations of the UGV 110 that enable the UGV 110 to navigate around the stretch of land 170 and perform its tasks by the UGV controller 116 is contemplated within the scope of the present disclosure.

The UGV communication module 118 may include a receiver and a transmitter configured to wirelessly communicate with other components of the system 100. The transmitter and/or the receiver of the communication module 118 may utilize any presently available communication protocols such as, for example, LTE, 5G, WiMax, WiFi, Bluetooth™, etc. to communicate with the other components of the system 100 through a network, e.g., Internet. It will be understood that the communication protocols used by the communication module 118 are not limited to those presently available, and as communication technology advances, other protocols may be used in the future. Thus, the scope of the present disclosure is not limited to presently available communication protocols, but also includes any communication protocols that may be available in the future.

For example, the communication module 118 enables the UGV 110 to communicate with the sensor 150 and/or the NAV processor 130. In some embodiments, the communication module 118 can receive sensor data from the sensor 150 and/or navigation signal from the NAV processor 130.

The toolkit 120 may include one or more tools or actuators enabling the UGV 110 to perform its functions. For example, the toolkit of a robotic grounds maintenance vehicle may include one or more set of blades structured and positioned for cutting grass on the ground within a property being maintained, and may further include one or more of a suction motor for sucking up cut grass and other debris, a container or a basket for collecting the sucked up grass and other debris, a hose for connecting the suction motor to the container or basket, as well as other tools generally suitable for a cutting and/or shaping grass on the ground. Other non-limiting examples of tools and/or actuators include lawn mower, hedge trimmer, string trimmer, tiller, cultivator, weed puller, pole saw, leaf blower, chain saw, hedge shears, pesticide sprayer, or any other tools suitable for landscaping and/or property maintenance. The toolkit for the UGV may, therefore, vary depending on the primary function of the robot.

In some embodiments, some or all of the tools within the toolkit for the tele-operated robot may be replaceable by a different tool such that the primary function of the tele-operated robot is changed.

While not shown in the drawings, the UGV 110 may include a sensor stack of its own. In such embodiments, the sensor stack may include sensors that can detect the performance of the UGV 110 relative to the task being performed as well as sensors associated with the operation of the UGV 110 (e.g., to determine the operational state of the the UGV 110, and/or the operational state of one or more tools and/or actuators from the toolkit 120). For example, in case of lawn mowing robot, the sensor stack may include a sensor for measuring various characteristics of the grass being mowed. Some non-limiting characteristics include height of the grass, color of the grass, frequency of occurrence of weeds within a given area, width of the grass blades, and the like. In some embodiments, the sensor stack of a lawn mowing robot may allow detection of various characteristics of the grass being mowed before and after the mowing operation is performed.

In some embodiments, data obtained from various sensor on-board the UGV 110 may be stored and/or transmitted for further analysis to enable improve the operations of the UGV 110 using machine learning or artificial intelligence models.

### B. Sensor

The sensor 150 may include one or more sensors that sense (or enable a local or remote operator or supervisor of the UGV 110 to sense) an environment surrounding the UGV 110. The sensor 150 includes a sensor stack 152, a processor 154 and a sensor communication module 156.

The sensor stack 152 may include at least one camera, and may optionally include one or more other sensors. The camera may be an optical camera, an infrared camera, an ultraviolet camera, and a stereo camera or a combination thereof. Non-limiting examples of the one or more other sensors in the sensor stack 152 include, but are not limited to, a LIDAR and/or a RADAR, an ultrasound sensor (e.g., a SONAR sensor), a GPS positioning system (not shown), and gyroscope(s).

Referring back to FIG. 1A, the sensor 150 may be mounted to a platform 140 that is spaced apart from the UGV 110. The platform 140 is at least temporarily fixed (i.e., stationary) relative to the stretch of land 170. In some embodiments, the sensor 150 is mounted to the platform 140 such that the sensor is positioned higher, relative to the stretch of land 170, than a topmost surface of the UGV 110. Thus, in some embodiments, the platform 140 may be a lamppost (as shown in FIG. 1A), or a roof, a tree or any other structure that is fixed relative to the stretch of land 170.

In some embodiments, the platform 140 may be a second vehicle (e.g., a second unmanned vehicle) that periodically follows the UGV 110. The second vehicle may be a ground vehicle (unmanned or human operated) or an aerial vehicle (unmanned or human operated). For example, in some embodiments, the second vehicle may be a tele-operated ground or aerial vehicle that can be operated remotely by a supervisor. Ground or aerial vehicles suitable for use as the second vehicle will depend, e.g., on the primary function of the primary UGV (e.g., UGV 110). In some embodiments, the sensor 150 provided on the second vehicle may be placed such that the sensor is positioned higher, relative to the stretch of land, than a topmost surface of the UGV (e.g., UGV 110).

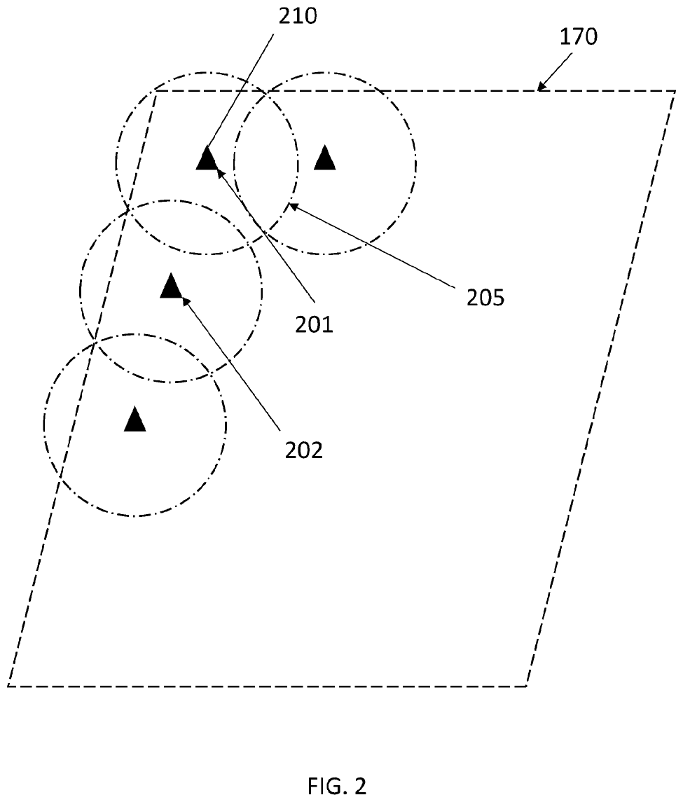

FIG. 2 illustrates the use of a second vehicle as a platform for providing sensors to enable navigation of an unmanned ground vehicle, in accordance with some embodiments of the present disclosure. Referring now to FIG. 2, in some embodiments, the second vehicle 210 may move to a first location 201 and stop while the UGV 110 performs the assigned task within a given range 205 from the first location 201. Once the task is completed within that range, the second vehicle may move to a second location 202 and stop while the UGV 110 performs the assigned task within the given range from the second location 202, and so on until the UGV 110 completes the assigned task over the desired stretch of land 170.

In some embodiments, the second vehicle 210 may be a ground vehicle or an aerial vehicle. In an example, a ground vehicle may be a second UGV similar to the UGV 110. Non-limiting examples of an aerial vehicle include a drone, a balloon, a blimp, an airship, a Zeppelin, a VTOL aircraft and a helicopter, that is capable of hovering at a fixed location for at least some amount of time. In some embodiments, the second vehicle 210 may be tethered to the UGV 110. In some embodiments, the tether between the UGV 110 and the second vehicle 210 may be configured to provide power to the second vehicle 210. In some embodiments, the tether between the UGV 110 and the second vehicle 210 may provide a data connection between the UGV 110 and the second vehicle 210.

In some embodiments, a plurality of second vehicles 210 may be simultaneously deployed to avoid occurrence of blind spots cause, for example, by occluded or obscured objects, by providing multiple vantage points for the sensor to obtain the requisite data. In such embodiments, the communication between the UGV 110 and one of the second vehicles 210 can be handed off to a second of the second vehicles 210 when the UGV 110 is approaching an edge of the range of the first of the second vehicles 210.

Those of ordinary skill in the art will appreciate that the second vehicle 210 may be replaced with or augmented by fixed mounting platforms (e.g., pillars, lamp posts, etc.) that are located at various positions on the stretch of land. In some embodiments, the position of the fixed mounting platforms may be optimized to cover the entirety of the stretch of land on which the UGV is to perform its primary function without leaving any blind spots.

In some embodiments, based on the data obtained from the sensor stack 152, the processor 154 detects the identifying marker 112 and thereby distinguishes the UGV 110 from the surrounding environment on the stretch of land 170. The processor 152 may additionally detects the position, velocity (i.e., speed and direction), and a pose (i.e., orientation relative to the stretch of land 170) of the UGV 110.

In some embodiments, the processor 154 generates a three-dimensional (3D) map of the stretch of land 170 using the data obtained from the sensor stack 152. The 3D map may be generated using any suitable algorithm known in the art including, but not limited to, image processing algorithms, and/or machine learning algorithms.

The 3D map may include, for example, information relating to various objects on the stretch of land 170. The information relating to an object may include, but is not limited to, position, texture, height, size, color, depth, hardness, weight, and/or other physical characteristics. The information relating to an object may further include whether the object is movable or fixed, whether the object may be moved by the UGV (i.e., small enough to be pushed aside without damaging the UGV or the tools thereof), whether the object is a live object (e.g., an animal, or a person), and the like.

In some embodiments, processor 154 identifies, based on the 3D map, one or more objects 175 present on the stretch of land 170 that may be considered as obstacles for the motion of the UGV. In such embodiments, the processor 154 may utilize various image processing and/or machine learning algorithms to distinguish the objects 175 from portions of the stretch of land 170 on which the UGV 110 can traverse. In addition to identifying the objects 175, the processor 154 may determine, in some embodiments, whether the UGV 110 can traverse over the object 175, but not perform the designated task while traversing over the object 175.

In some embodiments, the processor 154 may be configured to, based on the data obtained from the sensor stack 152, detect the performance of the UGV 110 relative to the task assigned to the UGV 110. For example, in embodiments where the UGV 110 is a grounds maintenance vehicle such as a lawn mower, the sensor 150 may include a sensor for detecting a height of the grass to be cut as well as height of the grass that has been cut. The processor 154 may detect the height of the grass using, for example, an image processing algorithm to determine a color of a patch of grass and determine the height of the grass in that patch based on the color of the grass, or determine the need for providing water to the patch based on the color of the grass. Similarly, in embodiments, where the UGV 110 is tasked to dig a hole in the ground, the processor 154 may determine the depth of the hole based on the sensor data obtained from the sensor stack. The processor 154 may utilize various image processing and/or machine learning algorithms to detect the performance of the UGV 110.

It will be appreciated that the scope of the present disclosure is not limited by the specific image processing and/or machine learning algorithms used for detecting objects on a terrain and/or detecting performance of the UGV in performing a particular task.

Like the UGV processor 114, the sensor processor 154 may include one or more processors such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

While FIG. 1B shows the processor 154 as being separate from the UGV 110, in some embodiments, the processor 154 may be part of the UGV 110 and/or the NAV processor 130. In some embodiments, the processor 154 may be part of the NAV processor 130. In some embodiments, the processor 154 may include a plurality of processors, with a first subset being part of the UGV 110 and a second subset being part of the NAV processor 130. In some embodiments, the processor 154 may further include a third subset of processors separate from the UGV 110 and the NAV processor 130.

The sensor communication module 156 enables the processor 154 to communicate with the UGV 110, e.g., via the UGV communication module 118, and/or the NAV processor 130 (e.g., via the NAV processor communication module 132). Thus, the sensor communication module 156 may include a receiver and a transmitter configured to wirelessly communicate with other components of the system 100. In embodiments where the processor 154 is not wholly a part of the sensor 150 (i.e., at least a portion of processor 154 is remote from the sensor 150), the sensor communication module 156 enables exchange of data between the sensor stack 152 and the portion of the processor 154 that is not part of the sensor 150.

The transmitter and/or the receiver of the sensor communication module 156 may utilize any presently available communication protocols such as, for example, LTE, 5G, WiMax, WiFi, Bluetooth™, etc. to communicate with the other components of the system 100 through a network, e.g., Internet. It will be understood that the communication protocols used by the sensor communication module 156 are not limited to those presently available, and as communication technology advances, other protocols may be used in the future, so long as the communication protocols are compatible with the communication protocols used by the UGV communication module 118 and/or the NAV processor communication module 132. Thus, the scope of the present disclosure is not limited to presently available communication protocols, but also includes any communication protocols that may be available in the future.

### C. NAV Processor

Like the UGV processor 114 and the sensor processor 154, the NAV processor 130 may include one or more processors such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

The NAV processor 130 may be part of a standalone processing unit (e.g., a part or whole of a cloud server), in some embodiments. While FIG. 1A shows the NAV processor 130 as being separate from the sensor 150 and the UGV 110, in some embodiments, the NAV processor 130 may be part of the sensor 150. In some embodiments, the NAV processor 130 may be part of the UGV 110. In some embodiments, the NAV processor 130 may include a plurality of processors, with a first subset being part of the UGV 110 and a second subset being part of the sensor 150. In some embodiments, the NAV processor 130 may further include a third subset of processors separate from the UGV 110 and the sensor 150.

The NAV processor 130 receives data from the sensor 150 (e.g., via the NAV processor communication module 132) and generates a navigation signal that is transmitted to the UGV 110 (e.g., via the UGV communication module 118).

The navigation signal includes information that can be used for navigating the UGV on the desired stretch of land. Thus, referring back to FIG. 1A, the navigation signal enables the UGV 110 to navigate in the stretch of land 170 by providing information relating to a prospective path for movement of the UGV 110 (e.g., to move around the stretch of land 170) to the UGV controller 116 of the UGV 110.

Accordingly, the navigation signal may include information associated with objects that can be considered as obstacles for motion of the vehicle on the stretch of land. Non-limiting information associated with an object that can be considered as an obstacle includes the type of the object, the coordinates of the object relative to a frame of reference in which the UGV operates, the size of the obstacle, characteristics of the stretch of land surrounding the object, and the like. Type of the object may be based on characteristics such as movable, immovable, live, and the like (e.g., determined using a machine learning algorithm). Characteristics of the stretch of land surrounding the object may include, for example, the topography of the land surrounding the object (e.g., slope of the land surrounding the object), whether, and how much, the primary operation of the UGV can be performed in the surrounding land, and the like.

The navigation signal may further include coordinates for a prospective path for movement of the UGV. The prospective path is selected so as to avoid the objects that are considered as obstacles, which are determined using the 3D map as discussed elsewhere herein. The prospective path may avoid the objects that are considered as obstacles by, e.g., determining a contour around each object considered as an obstacle where the UGV cannot perform its primary function. The prospective path is generally dependent on the pose and the velocity of the UGV.

Additionally, the prospective path may be determined based on the user-specified task, which, in turn, is based on the primary function of the UGV. For example, in embodiments where the UGV is a ground maintenance robot, the user-specified task may include mowing a stretch of land, trimming the grass around a structure (e.g., a tree, a wall, a fence, etc.), de-weeding a portion of that stretch of land, fertilizing a mowed stretch of land, and the like. Those of ordinary skill in the art would readily appreciate that paths required for performing different operations may be different. For example, in some instances, the UGV may be required to traverse a path to perform a portion of the task, and then retrace the path to perform a second portion of the task, or a traverse a different path for performing the second portion of the task.

In some embodiments, the prospective path may be determined for optimizing one or more parameters relating to the UGV and/or performance of the task. For example, in some embodiments, the prospective path may be selected to minimize the time needed to complete the task. In some embodiments, the prospective path may be selected to minimize the fuel consumption of the UGV. As yet another example, in some embodiments where the UGV includes a solar panel for recharging a battery, the prospective path may be selected to maximize the time spent by the UGV direct sunlight. In some embodiments, a user may select the parameter to be optimized when selecting the prospective path for the UGV.

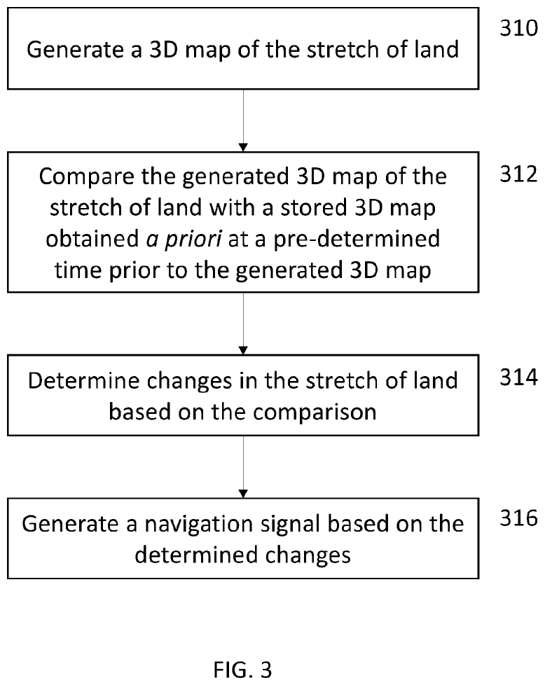

In some embodiments, generation of the navigation signal based on a presently obtained 3D map may be difficult because objects on the stretch of land may be obscured by debris or other externalities (e.g., snow). In such embodiments, previously obtained 3D maps may be used for generating a navigation signal. FIG. 3 is a flow chart illustrating an example method for generating a navigation signal in accordance with at least some embodiments of the present disclosure.

In some embodiments, the method for generating a navigation signal may include, at 310, generating a 3D map of the stretch of land (e.g., based on data obtained by the sensor stack 152).

At 312, the 3D map generated at 310 is compared with a stored 3D map (i.e., a priori obtained 3D map) of the stretch of land. The stored 3D map may be 3D map that was obtained a time before the 3D map generated at 310. For example, in embodiments, where the primary function of the UGV is snow removal (from grounds or roads), and the 3D map generated at 310 is based on the data obtained after a snowfall, the a priori obtained 3D map may be a 3D map generated based on data obtained prior to the snowfall.

At 314, changes in the stretch of land such as, e.g., change in location of objects, presence of additional objects, absence of previously present objects, change in size of objects, and the like, are determined based on the comparison of the 3D maps performed at 312. The changes may be indicative of objects that are newly present, objects that are no longer present or objects that are obscured by debris or externalities. In some embodiments, an additional determination is made regarding the presence, absence or obscuring of previously determined or new obstacles.

Based on the determined changes in the stretch of land, at 316, a navigation signal is generated to provide the prospective path for the UGV to perform its primary function on the stretch of land.

Referring back to FIG. 1B, in some embodiments, the sensor stack 152 is configured to detect one or more emitting beacons that are attached to or mounted on fixed objects on the stretch of land. For example, in some embodiments, the fixed objects on the stretch of land such as, for example, a building, a fence, a tree, a lamp post, etc., can be provided with emitting beacons that can be used to locate (e.g., using triangulation) the fixed objects, and the UGV relative to the fixed objects. Those of ordinary skill in the art will appreciate that increasing the number of emitting beacons may be useful in increasing the accuracy of location of the UGV on the stretch of land. The emitting beacons may be affixed to the fixed objects in some embodiments.

The navigation signal generated by the NAV processor 130 is then transmitted to the UGV 110, where the UGV controller 116 operates the UGV 110 in accordance with the navigation signal to perform the primary function of the UGV 110 on the stretch of land 170 while avoiding obstacles that can damage the UGV (or any of the tools thereof).

### D. Method for Obstacle Avoidance

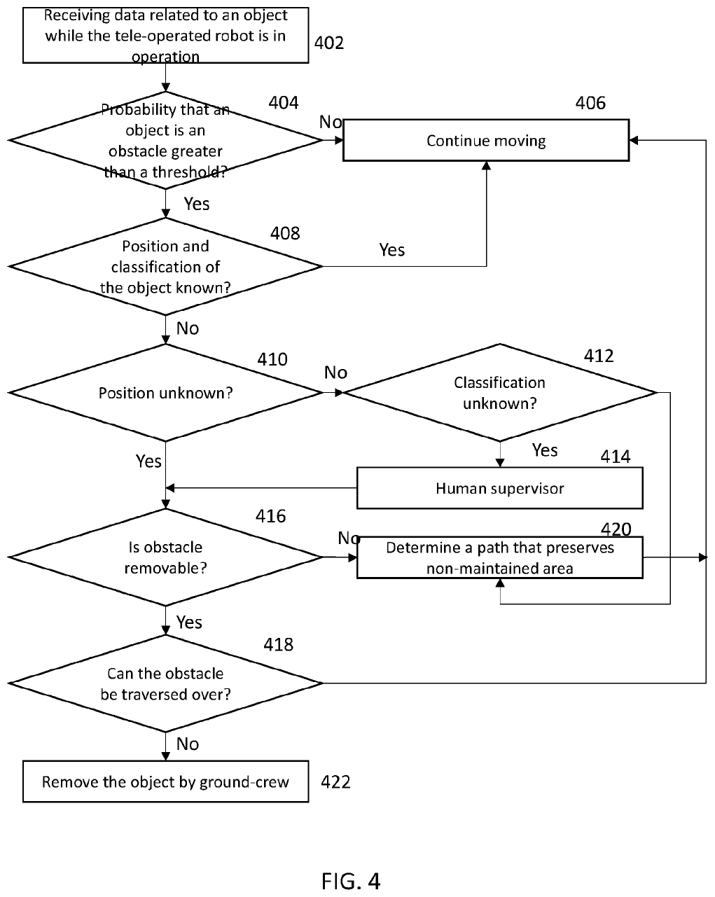

FIG. 4 illustrates a flow chart for a method for obstacle avoidance for a ground maintenance robot in accordance with at least some embodiments of the present disclosure. It will be understand that the while the method discussed with reference to FIG. 4 is for a ground maintenance robot such as, an unmanned lawn mower, the method can be suitably modified for operating other types of UGVs.

In an implementation, a method for operating a UGV for maintenance of a property such as a robotic lawn mower includes obtaining, at 402, during an autonomous operation of the UGV for maintenance of the property, data relating to an object in an operating path (e.g., a prospective path determined based on the 3D map generated using any of the methods disclosed herein) of the UGV using a sensor of the tele-operated robot. In some embodiments, the operating path may be predetermined based on a prior survey of the property. In some embodiments, the operating path may be determined based on real-time analysis of an environment surrounding the UGV (e.g., using any of the methods disclosed herein). The real-time analysis may be performed based on data obtained from sensors external to the UGV in some embodiments.

At 404, based on the data relating to the object, at a processor (e.g., the NAV processor 130), it is determined whether a probability that the object is an obstacle is greater than a threshold. The determination of whether the probability that the object is an obstacle is based on factors such as, for example, a detected shape and size of the object.

If it is determined that the probability that the object is an obstacle is not greater than the threshold, at 406, the control center causes the UGV to continue operating in the operating path.

If it is determined that the probability that the object is an obstacle is greater than the threshold, at 408, it is determined whether one or both of a position and a classification of the obstacle is previously known. An obstacle may be classified as, for example, movable, immovable, modifiable, non-modifiable, traversable, non-traversable, new, or old. The position may be considered as an absolute position relative to earth coordinates, or a relative position with respect to a pre-identified landmark on the property.

If it is determined that either the position or the classification of the obstacle is unknown, at 410, it is determined, at processor (e.g., the NAV processor 130), whether a position of the obstacle is unknown. Upon determination that the position of the obstacle is known, at 412, it is determined whether the classification of the object is unknown. If it is determined that the classification of the object is known, at 420, an alternate operating path that preserves the non-maintained area is determined. The UGV may then continue, at S206, operating in the alternate operating path.

On the other hand, if it is determined that the position of the obstacle is known but the classification of the obstacle is unknown, at 414, a process for inspection of the obstacle may be initiated to enable a determination of the classification of the obstacle. In some embodiments, the process includes causing a human supervisor to be deployed to determine the classification of the obstacle. In some embodiments, the human supervisor may further determine, at 416, whether the obstacle is removable from the property.

In some embodiments, the process for inspection of the obstacle includes causing a UAV to fly over the property in a flight path that is configured to determine the classification of the obstacle. In some embodiments, the UAV flight path is configured to obtain an aerial image comprising a three-dimensional (3D) geometrically corrected composite map of the property. The 3D geometrically corrected composite map is then transmitted to the control center or the tele-operated robot to enable estimation of an alternate operating path that preserves the non-maintained area. In some embodiments, the inspection is performed based on data obtained from more than one sensors providing vantage points (e.g., mounted to different mounting platforms 140).

Referring back to FIG. 4, if it is determined that the position of the obstacle is known, it is determined whether the classification of the obstacle is known, and at 416, it is determined whether the obstacle is removable from the property based on the data relating to the object (now determined to be an obstacle).

If it is determined that the obstacle is not removable from the property, at 420, an alternate operating path that preserves the non-maintained area is determined. The UGV may then continue, at 406, operating along the alternate operating path.

In contrast, if it is determined that the obstacle is removable, it is first determined, at 418, whether the obstacle can be traversed over. If it is determined that the obstacle can be traversed over, the UGV may continue, at 406, operating in the alternate operating path. And if it is determined that the obstacle cannot be traversed over, at 422, a process for manual removal of the obstacle is initiated. In some embodiments, the process may include causing a ground-crew to be deployed for removing the obstacle. In some embodiments, the process may include deploying an obstacle removal vehicle (which may be another UGV) for removing the obstacle.

Further details of and alternatives to the method avoiding obstacles are discussed in U.S. Pat. No. 10,906,181, which is incorporated herein by reference in its entirety for all purposes.

### E. Further Uses of Vantage Point Sensor Based Navigation

While the systems, methods and devices disclosed herein have been described for use in navigation of UGVs, the systems, methods and devices may be suitably modified for use in any bounded space where at least temporarily fixed vantage points can be provided. Examples of such uses cases include, but are not limited to navigation of water vessels such as, e.g., boats and ships. Thus, for example, a sensor stack may be mounted to a land-based vantage point, e.g., a pole or a tree on the shore of a lake or a river, or on a harbor, and data obtained from the sensor may be used for safely navigating a boat or a ship to a docking space.

Those of ordinary skill in the art will appreciate that while the mode of control of a ship or a boat is different from the mode of control of a UGV, the data (e.g., presence and characteristics of obstacles) used for navigating both types of vehicles is similar. Accordingly, the 3D maps generated using the systems, devices, and methods disclosed herein may be useful in generating prospective paths for navigating any kind of vehicle in a suitable space such as, for example, on a stretch of land or a bounded area in water.

### F. Further Considerations

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

The singular forms “a,” “an,” and “the” include plural referents unless the context clearly dictates otherwise. Thus, for example, reference to “a plunger component” includes reference to one or more plunger components, and reference to “the magnet” includes reference to one or more magnets.

In one or more aspects, the terms “about,” “substantially,” and “approximately” may provide an industry-accepted tolerance for their corresponding terms and/or relativity between items, such as from less than one percent to five percent.

As used herein, the term “substantially” refers to the complete or nearly complete extent or degree of an action, characteristic, property, state, structure, item, or result.

It is to be understood that a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 0.5 to 10 cm” should be interpreted to include not only the explicitly recited values of about 0.5 cm to about 10.0 cm, but also include individual values and sub-ranges within the indicated range. Thus, included in this numerical range are individual values such as 2, 5, and 7, and sub-ranges such as from 2 to 8, 4 to 6, etc. This same principle applies to ranges reciting only one numerical value. Furthermore, such an interpretation should apply regardless of the breadth of the range or the characteristics being described.

Unless otherwise defined, all technical and scientific terms used herein have the same meaning as commonly understood to one of ordinary skill in the art to which this disclosure belongs. Although any methods, devices and materials similar or equivalent to those described herein can be used in the practice or testing of the disclosure, representative methods, devices, and materials are described below.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Many modifications may be made to this configuration without departing from the scope or spirit of the claimed subject matter.

Although the detailed description contains many specifics, these should not be construed as limiting the scope of the subject technology but merely as illustrating different examples and aspects of the subject technology. It should be appreciated that the scope of the subject technology includes some embodiments not discussed in detail above. Various other modifications, changes and variations may be made in the arrangement, operation and details of the method and apparatus of the subject technology disclosed herein without departing from the scope of the present disclosure. Unless otherwise expressed, reference to an element in the singular is not intended to mean “one and only one” unless explicitly stated, but rather is meant to mean “one or more.” In addition, it is not necessary for a device or method to address every problem that is solvable (or possess every advantage that is achievable) by different embodiments of the disclosure in order to be encompassed within the scope of the disclosure. The use herein of “can” and derivatives thereof shall be understood in the sense of “possibly” or “optionally” as opposed to an affirmative capability.

1. A system for navigating an unmanned ground vehicle (UGV), comprising:
a UGV comprising a controller configured to receive a navigation signal and operate the UGV in accordance with the navigation signal, the UGV having an identifying marker provided thereon;
a sensor spaced apart from the UGV and at least temporarily fixed relative to a stretch of land on which the UGV is to operate, the sensor being configured to:
obtain a three-dimensional map of the stretch of land,
generate the navigation signal based on the three-dimensional map and a user-specified task, and
transmit the navigation signal to the controller.

2. The system of claim 1, wherein the UGV comprises a grounds maintenance vehicle, an agricultural vehicle, a road maintenance vehicle, or a combination thereof.

3. The system of claim 2, wherein the user-specified task comprises maintenance operation for a defined portion of the stretch of land.

4. The system of claim 1, wherein the sensor comprises an optical camera, an infrared camera, an ultraviolet camera, an ultrasound sensor, a radar, a LIDAR, or a combination thereof.

5. The system of claim 1, wherein the sensor is mounted to a body at least temporarily fixed relative to the stretch of land.

6. The system of claim 5, wherein the body is one selected from the group consisting of a pole, a wall, a roof, and a tree.

7. The system of claim 1, wherein the sensor is positioned higher than a topmost surface of the UGV.

8. The system of claim 1, wherein the sensor is mounted to a second vehicle that periodically follows the UGV.

9. The system of claim 1, wherein the sensor is mounted to an aerial vehicle capable of at least temporarily holding a position relative to the stretch of land.

10. The system of claim 9, wherein the aerial vehicle is one selected from the group consisting of a drone, a balloon, a blimp, an airship, a Zeppelin, a VTOL aircraft and a helicopter.

11. The system of claim 9, wherein the aerial vehicle is a drone tethered to the UGV or a body at least temporarily fixed to the stretch of land.

12. The system of claim 1, wherein the identifying marker comprises a machine readable marker enabling the sensor to distinguish the UGV from surrounding stretch of land.

13. The system of claim 12, wherein the identifying marker comprises at least portion thereof disposed on top and/or along one or more sides of the vehicle.

14. The system of claim 12, wherein the identifying marker comprises textural and/or structural characteristics detectable by the sensor.

15. The system of claim 12, wherein the identifying marker comprises a two-dimensional and/or a three-dimensional structure.

16. The system of claim 12, wherein the identifying marker is detectable across the electromagnetic spectrum and/or by ultrasound.

17. The system of claim 12, wherein the identifying marker comprises a multi-colored and textured two-dimensional code that is unique to the UGV.

18. The system of claim 1, wherein the controller is configured to autonomously operate the UGV within a predetermined range of the sensor based on the navigation signal.

19. The system of claim 1, wherein the three-dimensional map comprises three-dimensional information relating to a terrain of the stretch of land including objects that are obstacles for motion of the UGV.

20. The system of claim 1, wherein the sensor is further configured to determine a pose and a velocity of the UGV relative to the stretch of the land based on detection of the identifying marker.

21. The system of claim 20, wherein the navigation signal comprises information associated with:
objects that are obstacles for motion of the vehicle on the stretch of land, and a prospective path for movement of the UGV,
wherein the prospective path is selected to avoid the objects that are obstacles and is based on the user-specified task and the determined pose and velocity of the UGV.

22. The system of claim 21, wherein the sensor is further configured to determine, based on the three-dimensional map, the objects that are obstacles for motion of the UGV on the stretch of land.

23. The system of claim 1, wherein the sensor is configured to generate the navigation signal by:
comparing the generated three-dimensional map with an a priori obtained three dimensional map; and
determining changes in the stretch of land based on the comparison.

24. The system of claim 1, wherein the user-specified task comprises one or more agricultural processes including tilling, seeding, spraying of a fertilizer, a pesticide and/or a herbicide, and harvesting.

25. The system of claim 1, wherein the user-specified task comprises one or more road maintenance processes including snow removal, preventive management, salt or brine spraying, painting, and damage maintenance.

26. The system of claim 1, wherein the user-specified task comprises one or more of ground maintenance processes including lawn mowing, bush trimming, snow removal, seeding, aerating, watering, and spraying of a fertilizer, a pesticide and/or a herbicide.

27. The system of claim 1, wherein the user-specified task comprises one or more of solar farm maintenance processes including cleaning of solar panels.

28. The system of claim 1, wherein the user-specified task comprises one or more warehouse processes including loading and/or unloading of shelves, collecting objects from shelves, and packaging objects.

29. The system of claim 1, wherein the three-dimensional map comprises map elements containing attributes including color information and depth information.

30.-70. (canceled)
